(19) United States
(12) Patent Application Publication
(10) Pub. No.: US 2026/0154652 A1
(43) Pub. Date: Jun. 4, 2026

(54) TOOL FOR DELIVERY OF REMEMBRANCES TO RECIPIENTS POSTHUMOUSLY

(71) Applicant: Open when LLC, Olathe, KS (US)

(72) Inventors: April McKinney, Olathe, KS (US); Misty Cross, Las Vegas, NV (US)

(21) Appl. No.: 19/213,473

(22) Filed: May 20, 2025

Related U.S. Application Data
(60) Provisional application No. 63/727,292, filed on Dec. 3, 2024.

(51) Int. Cl. G06Q 10/0832; H04L 9/08; H04L 9/32

(52) U.S. Cl. CPC G06Q 10/0832; H04L 9/0819; H04L 9/3231

(57) ABSTRACT

A posthumous memory-sharing system including a memory storage system storing user-selected digital content and instructions for communicating with a computing device of a recipient. The memory storage system authenticates death of the user based on receiving biometric data and/or third-party data validation, then transmits verification to the computing device that the death of the user has been authenticated. The memory storage system also receives a unique, recipient-specific encryption key indicating that the recipient wishes to receive at least some of the user-selected digital content or at least one physical item associated with the recipient. In response to receiving the encryption key, the memory storage system sends the user-selected digital content or initiates delivery of the physical item at user-specified or algorithmically determined times. The memory storage system also dynamically adjusts delivery schedules of these items based on recipient availability or real-time interaction feedback.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/727,292; titled “Tool for Delivery of Remembrances to Recipients Posthumously”; and filed Dec. 3, 2024. The Provisional Application is hereby incorporated by reference, in its entirety, into the current patent application.

### BACKGROUND OF THE INVENTION

Modern advancements in digital technology have transformed the ways in which individuals document, share, and preserve memories. Through smartphones, digital cameras, and social media, people are now able to capture significant life moments and share them with loved ones instantaneously. While these tools provide immediacy, they are often limited in their ability to ensure the preservation and meaningful delivery of memories over extended periods, particularly for individuals who wish to share messages and memories with loved ones after their passing. This desire to leave behind personalized messages or gifts can be an essential part of preserving one's legacy and offering comfort to loved ones, yet current options are limited in both functionality and personalization, often failing to meet these unique, sensitive needs.

Thus, there is a need for a comprehensive memory-sharing system that overcomes the deficiencies of the prior art.

### SUMMARY OF THE INVENTION

Embodiments of the current invention address one or more of the above-mentioned problems and provide a distinct advance in the art of memory-sharing or gift-sharing systems. In one or more embodiments, a posthumous memory-sharing system includes a computing device of a recipient having at least one processor and at least one memory device. The computing device is communicably coupled with a memory storage system associated with a user and storing user-selected digital content. The computing device may receive verification from the memory storage system authenticating death of the user. This authenticating may require biometric data and/or third-party data validation. The computing device may also, in response to receiving the verification of the death of the user, transmit a unique, recipient-specific encryption key indicating that the recipient wishes to receive any of the user-selected digital content or at least one physical item associated in the memory storage system with the recipient. The computing device may also receive from the memory storage system, in response to the transmission of the unique, recipient-specific encryption key, one or more of the user-selected digital content at user-specified or algorithmically determined times, or an alert regarding upcoming delivery of the at least one physical item at the user-specified or algorithmically determined times. Finally, the computing device may dynamically adjust delivery schedules of the one or more of the user-selected digital content or the at least one physical item based recipient availability and/or real-time interaction feedback received by the computing device to enhance the personalization and emotional impact of the shared content.

In yet another embodiment, a non-transitory computer-readable storage media having computer-executable instructions for posthumous gifting is provided. When executed by at least one processor, the computer-executable instructions cause the at least one processor to verify a user's death upon receipt of third-party data validation and, at user-specified or algorithmically determined dates or times following verification of the user's death, instruct the at least one processor release or send stored digital content to one or more designated recipients, and initiate dispatch of one or more physical items to the one or more designated recipients for delivery at the user-specified or algorithmically determined dates or times. Furthermore, the computer-executable instructions may cause the at least one processor to receive from at least one of the one or more designated recipients availability information or sentiment feedback and automatically adjust schedules for the releasing, the sending, or the delivery of at least one of the stored digital content and the one or more physical items based on the availability information or the sentiment feedback to enhance personalization and emotional impact of the digital content or the one or more physical items.

In some embodiments, a posthumous memory-sharing system including a memory storage system storing user-selected digital content and instructions for communicating with a computing device of a recipient. The memory storage system authenticates death of the user based on receiving biometric data and/or third-party data validation, then transmits verification to the computing device that the death of the user has been authenticated. The memory storage system also receives a unique, recipient-specific encryption key indicating that the recipient wishes to receive at least some of the user-selected digital content or at least one physical item associated with the recipient. In response to receiving the encryption key, the memory storage system sends the user-selected digital content or initiates delivery of the physical item at user-specified or algorithmically determined times. The memory storage system also dynamically adjusts delivery schedules of these items based on recipient availability or real-time interaction feedback.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a flow chart of one or more systems and components thereof configured for posthumously gifting and/or memory-sharing, in accordance with embodiments described herein;

FIG. 2 is a flow chart of a user interaction interface hub of FIG. 1, in accordance with embodiments described herein;

FIG. 3 is a flow chart of a verification and security module center of FIG. 1, in accordance with embodiments described herein;

FIG. 4 is a flow chart of a scheduling and atomic clock synchronization center of FIG. 1, in accordance with embodiments described herein;

FIG. 5 is a flow chart of an automated dispatch and logistic control center of FIG. 1, in accordance with embodiments described herein;

FIG. 6 is a flow chart of a recipient interface and sentiment feedback processor of FIG. 1, in accordance with embodiments described herein; and

FIG. 7 is a location-aware and adaptive communication hub of FIG. 1, in accordance with embodiments described herein.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

Embodiments here disclose a posthumous memory-sharing system that provides a comprehensive and deeply personalized approach for delivering digital memories and physical items to designated recipients, offering a seamless remembrance experience after the user's passing or death. Designed to integrate digital and tangible memory-sharing, this system combines automated storage, secure communication, and adaptive content delivery to honor the user's intentions.

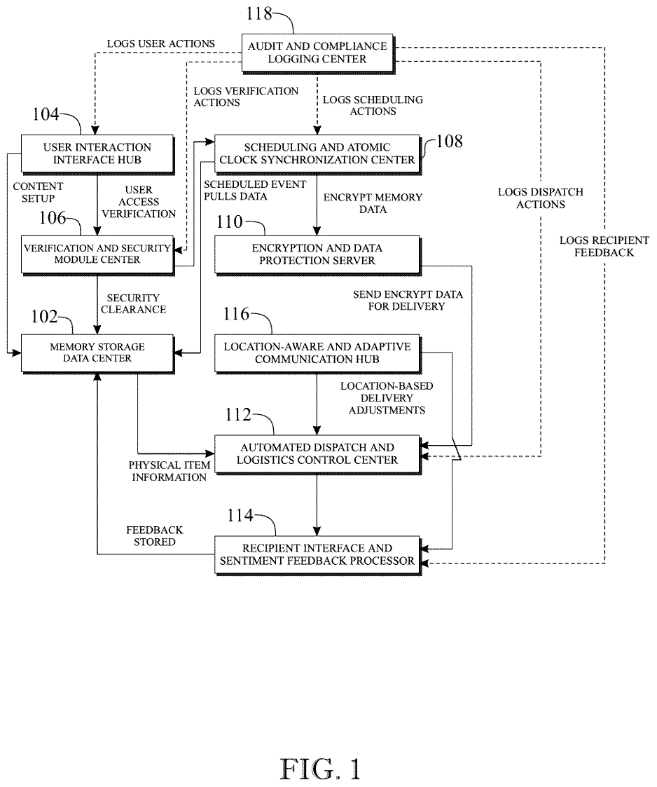

Turning initially to FIG. 1, an overall view of the disclosed system 100 is shown. The system includes: a memory storage data center 102, a user interaction interface hub 104, a verification and security module center 106, a scheduling and atomic clock synchronization center 108, an encryption and data protection server 110, an automated dispatch and logistics control center 112, a recipient interface and sentiment feedback processor 114, a location-aware and adaptive communication hub 116, and an audit and compliance logging center 118. One or more of these elements may be located remotely from others of these elements without departing from the scope of the technology herein. Furthermore, some of the method steps or processes described herein may be performed by any one or more of these system elements without departing from the scope of the technology herein. In some embodiments, one or more of these elements may be eliminated or combined into a single device, module, component, or system without departing from the scope of the technology described herein. The elements in FIG. 1 may be combine in a secure networked architecture, coordinating memory storage, scheduling, and personalized delivery to create a secure, adaptive, and meaningful memory-sharing experience.

The memory storage data center 102 may be part of a memory storage system having at least one processor and at least one memory device and may be configured for storing user-selected digital content and instructions for communicating with a computing device of a recipient, such as a recipient's computing device (e.g., phone, tablet, laptop, desktop computer, or other such computing devices). In some embodiments, the memory storage data center 102 is the core repository for all user-curated digital content, including multimedia files like audio (e.g., particular songs or a recorded audio message), video, images, GIFs (also known as Graphics Interchange Format files), electronic cards or e-cards, other types of documents, and/or text. The digital content maybe provide by the user prior to the user's death via software or apps on a user device or user computing device (e.g., phone, tablet, laptop, desktop computer, or other such computing devices).

The memory storage data center 102 may use storage arrays organized by emotional significance and recipient type (e.g., recipient relationship data), or other metadata provided by the user, to ensure efficient categorization and retrieval. In some embodiments, the memory storage data center 102 may include and/or communicate with one or more machine learning processors, and the machine learning processors may prioritize memories based on the recipient's relationship with the user, dynamically adjusting for personalized delivery. The memory storage data center 102 may store recipients and relevant delivery data (e.g., mail address or email address), as well as user-specified or algorithmically determined times for delivery of gifts or digital content, such as significant dates and recurring events.

The memory storage data center 102 may further be configured to receive from the user and store data regarding physical items or physical gifts to send to one or more recipients following the user's death. The physical items may include traditional gifts such as flowers, cards, keepsakes, jewelry, toys, or clothes. The physical items may also include food. For example, the memory storage data center 102 may store fast food or other restaurant selections and/or specialty food selections to be delivered to a specific recipient on a particular date. Furthermore, in some embodiments, the memory storage data center 102 may store information regarding physical cards selected by the user to be delivered (e.g., by mail or other delivery services) to a recipient on a particular date. The user may even provide a handwritten message to be stored in the memory storage data center 102, and the handwritten message may be transferred onto the card prior to delivery. In one or more embodiments, the physical gifts may include memory and/or health books. Additionally or alternatively, the memory and/or health books may be part of the user-selected digital content as virtual books that the user can create to have sent to specific recipients of their choice following the user's death. The memory books may comprise pictures, videos, text, and the like, while the health book may comprise the user's health history, which may be important for family members when providing physicians with their family health history. In one or more embodiments, a hologram box or other forms of holograms, 3D-printed images, or the like may be obtained by the user prior to their death and then may be delivered to the recipient of their choice following the user's death.

In some embodiments, the memory storage data center 102 may be communicably coupled with the automated dispatch and logistic control center 112 and may be configured to coordinate with third-party providers to purchase and send physical items based on user selections prior to the death of the user, as later described herein. In one or more example embodiments, the memory storage data center 102 may also store financial institution data such as bank account or trust account information, such that payments for future gifts may be provided to third-party providers using that financial institution data and/or the user's bank or trust account information.

In one or more embodiments, the memory storage data center 102 may store a prepaid burial receipt, relevant cemetery contact information, and other relevant funeral or burial data, such as a plan for the user's funeral. Furthermore, in one or more embodiments, the memory storage data center 102 may include data regarding wills and trusts for the user. For example, the user may create their wills and trusts via a live chat or artificial intelligence (AI)-assisted chatbot using the software or apps on the user device or the user computing device. In addition to assisting the user, AI or an age progression software or services may be provided by or communicably coupled with the memory storage data center 102 to provide age progression pictures of the user at various user-selected dates or important events following the user's death. These and other AI-assisted features may be made available both to the user and/or the recipient via the various systems and modules described herein.

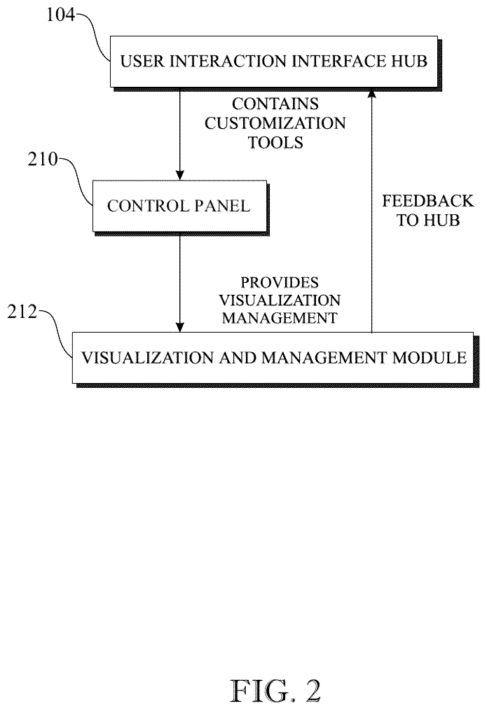

Turning to FIG. 2, the user interaction interface hub 104 is a web-based or mobile-accessible platform where users set up, personalize, and review their memory-sharing preferences to be stored in the memory storage data center 102, such as the data and information described above. The user interaction interface hub 104 may include, for example, a control panel 210 for customizing delivery schedules, sequencing memories, and previewing content. This control panel 210 allows users to visualize and manage content (e.g., via a visualization and management module 212), ensuring they can see how each memory will appear to recipients. For example, the web-based or mobile-accessible platform may be stored on and/or accessible by a user device such as a smart phone, tablet, laptop, desktop computer, or any other computing device known in the art. The control panel 210 may be a graphic control panel provided on a display screen of the user device, or alternatively may comprise a physical control panel, for receiving instructions from and selections made by the user prior to the user's death.

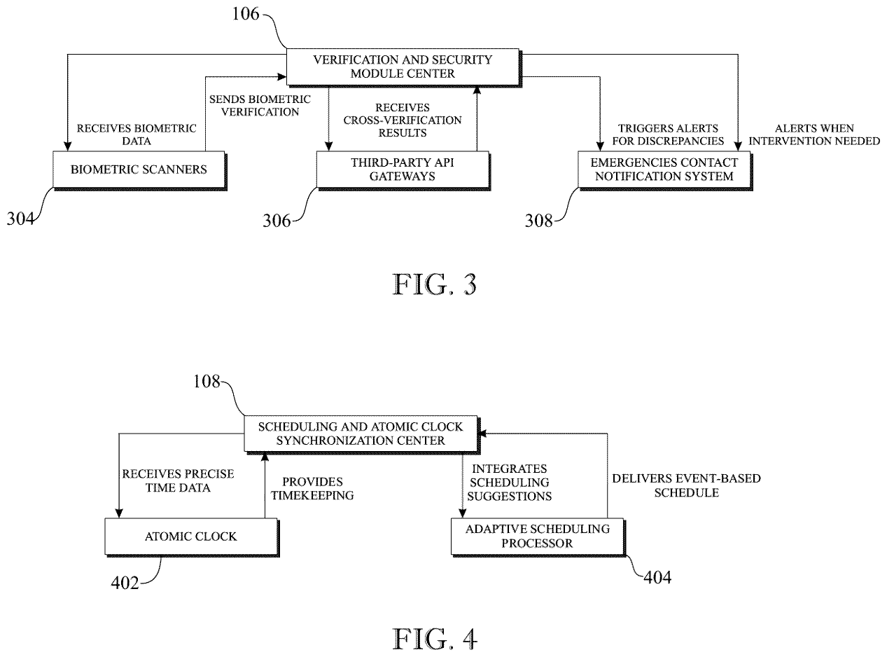

Turning to FIG. 3, the verification and security module center 106 may be configured to ensure that memories are released only upon verified death, employing multi-layered authentication and validation. In some embodiments, the verification and security module center 106 includes and/or is communicably coupled with biometric scanners 304, which collect and verify user biometrics as part of the initial verification process. Furthermore, in some embodiments of the invention, the verification and security module center 106 includes and/or is communicably coupled with third-party API gateways 306, which may interact with external databases, such as government or social media records, to cross-reference user status (e.g., government records and/or social media mentions indicating that the user is deceased) and add a layer of validation. Additionally or alternatively, the verification and security module center 106 may include an emergency contact notification system 308 designed to alert designated individuals if discrepancies occur during verification or if manual intervention is needed. The verification and security module center 106 serves as a central orchestrator, coordinating data from the biometric scanners 304 and the third-party API gateways 306 for a thorough validation process. If any step fails or requires additional checks, the emergency contact notification system 308 may be automatically activated to maintain oversight and ensure secure, authorized access.

Turning to FIG. 4, in the scheduling and atomic clock synchronization center 108, timing for memory release may be controlled with high precision. For example, the scheduling and atomic clock synchronization center 108 may include an atomic clock 402, which ensures long-term accuracy for delivery schedules, as well as an adaptive scheduling processor 404, which analyzes user-defined preferences and significant dates to suggest optimal delivery timings, aligning memory releases with meaningful events in recipients'lives. The scheduling and atomic clock synchronization center 108 may act as the coordinating unit, using input from the atomic clock 402 for precise timekeeping and leveraging the adaptive scheduling processor 404 to tailor the schedule based on important personal events or even recipient feedback, as later described herein. However, other processors or processing elements described herein may coordinate delivering of the digital content and/or physical items or gifts as described herein without departing from the scope of the technology herein.

The encryption and data protection server 110, as depicted in FIG. 1, may be configured to handle secure data encryption, generating unique, one-time-use keys for each memory release. In one or more embodiments, a built-in self-destruct protocol activates upon multiple failed access attempts, protecting sensitive data from unauthorized access.

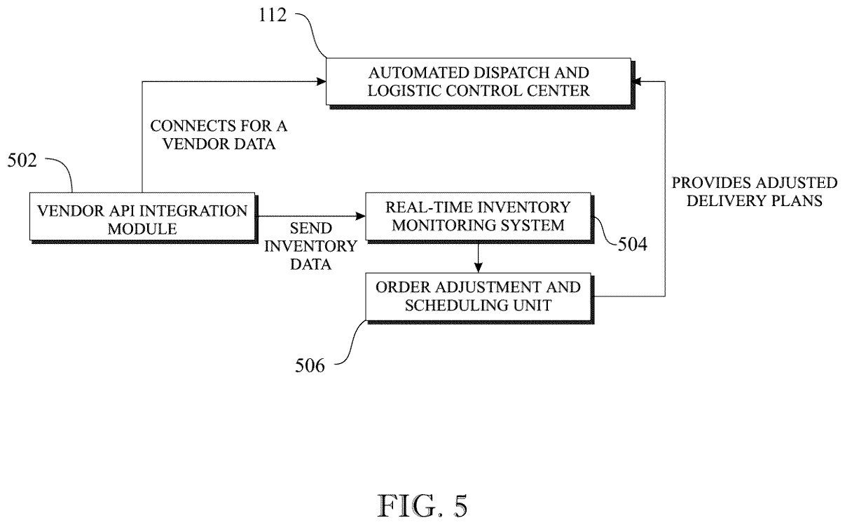

Turning to FIG. 5, in some embodiments of the invention, the automated dispatch and logistics control center 112 acts as the main orchestrator for the delivery process. For example, the automated dispatch and logistics control center 112 communicates with a vendor API integration module 502 to establish and maintain real-time connections with third-party vendors. In one or more embodiments, the vendor API integration module 502 supplies data about stock levels (i.e., how many of the physical item or gift are in stock) and availability to a real-time inventory monitoring system 504, which continuously tracks this information to detect changes or shortages. In one or more embodiments, the real-time inventory monitoring system 504 relays its findings to an order adjustment and scheduling unit 506, which processes this data to make necessary modifications to delivery plans. The order adjustment and scheduling unit 506, in some example embodiments, is configured to ensure that orders are adjusted in accordance with current inventory levels and aligns them with user-defined preferences for specific delivery dates or times. Specifically, in some embodiments the automated dispatch and logistics control center 112 is configured to rely on the order adjustment and scheduling unit 506 to coordinate and finalize delivery plans based on the monitored data, ensuring that each delivery is timely and matches user expectations. The interconnected workflow between these elements enables seamless adaptation and scheduling of physical item dispatches.

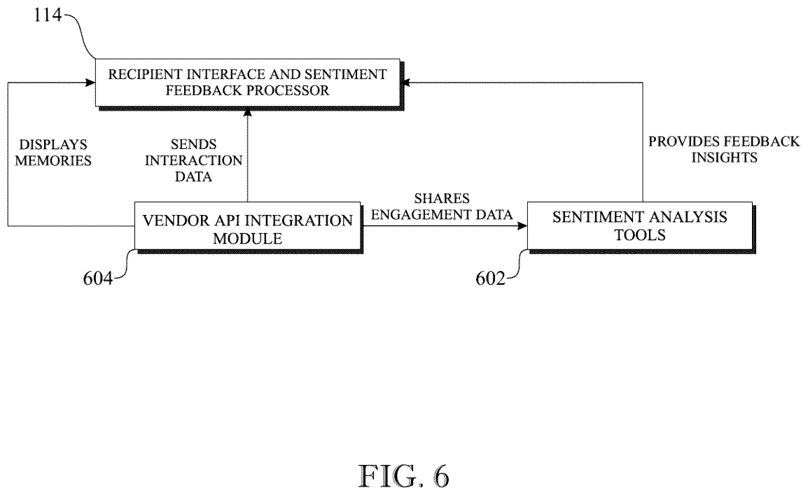

Turning to FIG. 6, in one or more embodiments, the recipient interface and sentiment feedback processor 114 serves as the primary platform for recipients to receive and view memories. For example, the recipient interface and sentiment feedback processor 114 may be stored on and/or accessed by the recipient's computing device to provide selectable feedback or sentiment feedback. Specifically, the recipient interface and sentiment feedback processor 114 can incorporate sentiment analysis tools 602, which gather feedback based on engagement metrics such as how long users interact with content, their emotional responses, and their selection of specific responses (such as selecting an emoji or an emotion from a list of emojis or emotions). In one or more example embodiments, the recipient interface and sentiment feedback processor 114 includes a gallery view 604, which organizes memories into categories by type or theme, providing a structured way for recipients to browse content via a screen or user interface of the recipient's computing device. The recipient interface and sentiment feedback processor 114 connects with the gallery view 604 to display memories and capture interaction data, which can then be sent to the sentiment analysis tools 602 for processing. The sentiment analysis tools 602 analyze this data to assess user reactions, and the resulting insights can be used by the recipient interface and sentiment feedback processor 114 to tailor future memory releases. This relationship forms a feedback loop where interactions with the gallery view 604 inform the sentiment analysis tools 602, ultimately guiding personalized adjustments in future content delivery. The recipient interface and sentiment feedback processor 114 may also be configured to receive recipient selections regarding a requested change in delivery location (e.g., if the recipient has moved) or a preference in modifying a delivery time to a more convenient time, or even communicating a preference to no longer receive some or all of the digital content or physical items or gifts. For example, if a widow remarries and finds it awkward to continue to receive gifts from her late husband at the home where she resides with her new spouse, she may request that the gifts no longer be sent or that they be sent to another location such as her office.

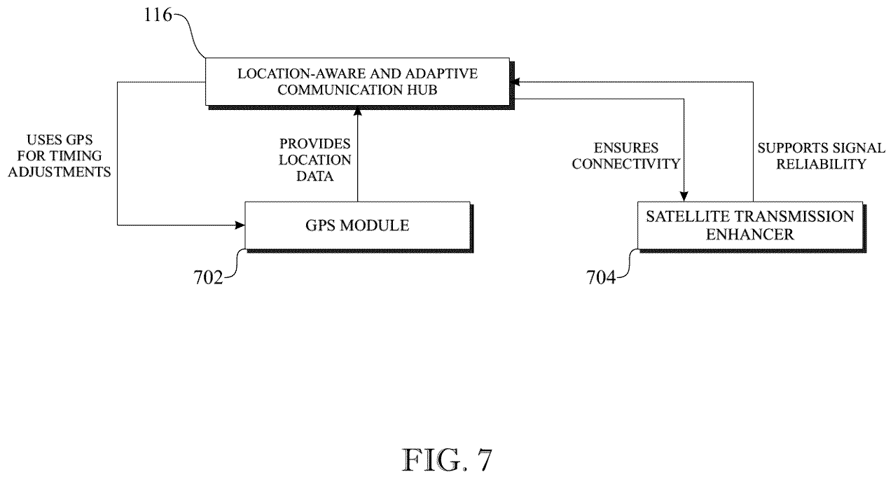

Turning to FIG. 7, in one or more embodiments, the location-aware and adaptive communication hub 116 ensures message reliability across various regions and adapts delivery based on the recipient's location. For example, the location-aware and adaptive communication hub 116 may include a GPS module 702, which modifies delivery timing when recipients are in sensitive locations to ensure appropriate timing of message releases, and a satellite transmission enhancer 704, which maintains connectivity in remote or low-signal areas, ensuring that messages reach recipients without interruption. In one or more embodiments, the location-aware and adaptive communication hub 116 acts as the main coordinator, using the GPS module 702 to adjust timing and the satellite transmission enhancer 704 to maintain reliable transmission. These elements work together to adaptively manage and deliver messages based on real-time location data and connectivity conditions.

Finally, in some embodiments, the audit and compliance logging center 118 (as in FIG. 1) maintains a comprehensive, secure log of all memory delivery events. This log records details like timestamps, recipient information, and delivery methods, ensuring accountability and transparency throughout the memory-sharing process. The log data may be shared with an intended recipient notifying that recipient when to expect delivery of a particular physical item or gift, such that the recipient may make appropriate arrangements to receive the same (e.g., making sure someone is home to receive a food delivery).

Various examples of the system and its components and their relationships in use are further described as follows. In some embodiments, central to the systems described herein, is a memory storage array that holds various forms of multimedia content—such as audio, video, images, GIF, and text—that the user has curated. In some embodiments, each file is organized based on emotional significance, with metadata that assigns priority to key memories, ensuring they are shared first. In some example embodiments, content is further arranged by relationship, with hierarchical data structures categorizing memories by recipient type, such as family, friends, or colleagues. This structure, enhanced by machine learning algorithms, may allow the system to select the most meaningful content for each recipient based on their relationship with the user.

In one or more embodiments, users interact with the system through a customizable interface (e.g., provided on a user interface or display) that enables the user to define delivery schedules, personalize content formats, and arrange memories in sequences that align with an intended narrative. Specific file types or themes can be selected for each recipient, creating a unique experience that reflects the user's wishes. Additionally, the interface can be configured to allow the user to preview and organize the content for each recipient, providing a high degree of control over posthumous communications.

As described above, the system includes a robust multi-layer verification mechanism to prevent unauthorized activation. This verification process integrates biometric data, third-party validation, and cross-verification with external sources, such as public databases and social media platforms, ensuring accuracy upon the user's death. An emergency contact alert provides further security, allowing for manual intervention if verification fails. A cloud-based backup system may also be included in some embodiments herein, strengthening this verification layer by checking across multiple databases to ensure an accurate, secure confirmation of the user's passing or death.

The scheduling module advantageously leverages an atomic clock to deliver content with long-term precision, allowing for memory releases that span years. Users can set adaptive schedules that align with significant dates, such as birthdays, anniversaries, or other meaningful occasions, creating a memory-sharing experience that resonates with recipients. The scheduling module can also include a predictive model that uses user history to suggest optimal delivery dates, further personalizing the timing of each release. For added flexibility, an override feature allows family members/recipients to adjust delivery schedules in sensitive cases, ensuring that each memory release occurs when recipients are ready.

To enhance security, some embodiments of the system may incorporate a custom encryption processor that generates a unique, one-time-use encryption key for each recipient per release. This recipient-specific encryption protects each message, ensuring it is accessible only to the intended individual. For example, in response to the transmission of the unique, recipient-specific encryption key, the recipient's computer device may receive age progressed images of the user for a given date based on a date associated with an image of the user retrieved from the memory storage system or the memory storage data center 102. Likewise, in some example embodiments, in response to the transmission of the unique, recipient-specific encryption key, the recipient's computer device may receive (and/or display) from the memory storage system or the memory storage data center 102 virtual memory books, health books providing the user's health and medical records, the user's will, trust, funeral instructions, and/or data regarding prepaid burial arrangements. In one or more embodiments, a self-lock or self-destruct function within the encryption protocol can be automatically activated if multiple unauthorized attempts are made, safeguarding against data breaches. Additionally, the system can be configured to support international carrier protocols to enable seamless global delivery, adapting to region-specific requirements to avoid disruptions.

The automated dispatch controller described herein can coordinate with third-party vendors to handle the delivery of physical items, such as flowers, framed photographs, and other personalized gifts, in accordance with user-defined preferences. In some embodiments, real-time inventory data allows a controller to adjust dispatch schedules based on vendor availability, substituting items if necessary to avoid delays. In some embodiments, user preferences for back-up gifts can be used to determine what to substitute or what alternative vendor to use if the gift is no longer available at its scheduled delivery time. Additionally or alternatively, a pre-ordering feature can ensure that items are secured in advance, particularly for significant dates, aligning with recipient preferences to provide reliable, timely delivery. Based on user-selected preferences, physical items can be further personalized with messages tailored to the recipient's relationship with the user, creating a memorable experience.

In one or more embodiments, for emotional preparedness, recipients can be provided with adaptive message previews that give subtle hints about each memory's theme, allowing the recipient to anticipate the content. The recipient interface can include a gallery view that organizes memories by type, event, or theme, allowing recipients to reflect on shared moments more deeply. Real-time interaction feedback can be tracked by a sentiment analysis module (e.g., the sentiment analysis tools 602), which logs access times, emotional reactions, and engagement metrics. This feedback can enable the system to adjust future deliveries based on recipient responses, providing an empathetic and responsive memory-sharing experience.

In some embodiments, the system herein leverages advanced AI capabilities to enhance the relevance and quality of shared memories. Machine learning algorithms in the storage array can prioritize content based on the recipient's relationship with the user, selecting the most significant memories. In one or more embodiments, an AI-based media enhancement tool converts older or degraded files into high quality images, video, or audio, preserving the emotional impact of each memory. Data compression algorithms further optimize storage capacity, maintaining high-resolution quality for large files without compromising efficiency.

In some embodiments, adaptive scheduling features include location-based or GPS event triggers that can delay or adjust delivery if a recipient is near sensitive locations, such as a family gathering. This location-aware functionality, combined with the scheduling module's predictive algorithm, can advantageously provide a nuanced approach to timing memory releases. In addition, a location-based delivery algorithm within the communication module can prioritize satellite transmission in areas with weak connectivity, ensuring message reliability even in remote or low-signal regions.

In one or more embodiments, a comprehensive audit log is maintained within the system, recording each delivery event, including recipient, date, content type, and/or method of delivery. This log provides a secure verification history accessible to authorized individuals, allowing for accountability and tracking of all system activities.

In one or more embodiments herein, a method of posthumously receiving digital content and/or physical items is described below. Specifically, in some embodiments the method may be performed by a computing device of a recipient having at least one processor and at least one memory device and being communicably coupled with a memory storage system that is associated with a user and stores user-selected digital content. For example, the method can include receiving verification from the memory storage system authenticating death of the user. The authenticating of the user's death can, in some embodiments, require at least one of biometric data and third-party data validation.

Furthermore, the method may include, in response to receiving the verification of the death of the user, transmitting a unique, recipient-specific encryption key. The unique, recipient-specific encryption key can, for example, indicate that the recipient wishes to receive some or all of the user-selected digital content or at least one physical item associated in the memory storage system with the recipient.

The method may also include receiving from the memory storage system, in response to the transmission of the unique, recipient-specific encryption key, at least one of the following: (1) one or more of the user-selected digital content at user-specified or algorithmically determined times, and (2) an alert regarding upcoming delivery of the at least one physical item at the user-specified or algorithmically determined times. For example, in response to the transmission of the unique, recipient-specific encryption key, the computing device of the recipient may receive from the memory storage system information or data regarding the user's will, trust, funeral instructions, and/or data regarding prepaid burial arrangements. Furthermore, in some example embodiments, in response to the transmission of the unique, recipient-specific encryption key, the computing device of the recipient may receive age progressed images of the user for a given date based on a date associated with an image of the user retrieved from the memory storage system (e.g., the memory storage data center 102). Additionally or alternatively, in some example embodiments, in response to the transmission of the unique, recipient-specific encryption key, the computing device of the recipient may receive and display at least one of memory books and health books providing health and medical records related to the user.

Finally, the method may include dynamically adjusting delivery schedules of the one or more of the user-selected digital content or the at least one physical item based on at least one of recipient availability and real-time interaction feedback received by the computing device to enhance the personalization and emotional impact of the shared content. Additionally or alternatively, in some embodiments the posthumous memory-sharing system may further comprise the memory storage system (e.g., the memory storage data center 102), and the memory storage system may be configured to coordinate with third-party providers to purchase and send physical items based on user selections prior to the death of the user.

A second alternative method for posthumous gifting may include one or more of the following steps or computer-executable instructions performed via at least one processor. Specifically, the method may include verifying a user's death or passing upon receipt of third-party data validation. Furthermore, the method may include, at user-specified or algorithmically determined dates or times following verification of the user's death: (1) releasing or sending stored digital content to one or more designated recipients, and/or (2) initiating dispatch of one or more physical items to the one or more designated recipients for delivery at the user-specified or algorithmically determined dates or times.

Furthermore, this second alternative method may include the steps of receiving from at least one of the one or more designated recipients availability information or sentiment feedback and automatically adjusting schedules for the releasing, the sending, or the delivery of at least one of the stored digital content and the one or more physical items based on the availability information or the sentiment feedback to enhance personalization and emotional impact of the digital content or the one or more physical items. In some embodiments, the digital content is organized and prioritized based on user-defined metadata and recipient relationship data. The second alternative method may further include generating unique, recipient-specific encryption keys for each scheduled release, ensuring secure access to the digital content.

In some embodiments, the second alternative method may include one or more steps that are provided as computer-executable instructions. One or more embodiments of the second alternative method may further include causing or instructing the at least one processor to transmit the digital content over secure, multi-channel networks, including cellular and satellite connections, to reach recipients regardless of location. Additionally or alternative, the second alternative method may comprise causing or instructing the at least one processor to coordinate with third-party providers to purchase and send physical items based on user selections prior to the user's passing. As described elsewhere herein, the physical items can include at least one of flowers, cards, framed photographs, other keepsakes, jewelry, toys, clothes, a hologram box, a 3D-printed image, and a food item.

In a third alternative method herein for posthumous memory-sharing and/or gifting, the method may be performed, for example, by a memory storage system (e.g., the memory storage data center 102) having at least one processor and at least one memory device and storing user-selected digital content and instructions for communicating with a computing device of a recipient. The memory storage system is communicably coupled with the computing device of the recipient. Furthermore, the memory storage system may be programmed and/or otherwise configured to perform the steps of the third alternative method herein, as described below (or any other method steps described herein).

Specifically, the third alternative method includes authenticating death of the user based on receiving at least one of biometric data and third-party data validation. The third alternative method further includes transmitting verification to the computing device that the death of the user has been authenticated. Additionally, the third alternative method includes receiving a unique, recipient-specific encryption key indicating that the recipient wishes to receive at least some of the user-selected digital content or at least one physical item associated in the memory storage system with the recipient.

In one or more embodiments, the third alternative method further includes, in response to the transmission of the unique, recipient-specific encryption key: (1) sending one or more of the user-selected digital content at user-specified or algorithmically determined times, and/or (2) initiating delivery of the at least one physical item at the user-specified or algorithmically determined times. Furthermore, the third alternative method may include a step of dynamically adjusting delivery schedules of the one or more of the user-selected digital content or the at least one physical item based on at least one of recipient availability and real-time interaction feedback received by the computing device to enhance the personalization and emotional impact of the shared content. In one or more embodiments, the third alternative method may include coordinating with third-party providers to purchase and send the at least one physical item based on user selections prior to the death of the user. Furthermore, the third alternative method may include transmitting data regarding the user's will, trust, funeral instructions, and data regarding prepaid burial arrangements to the computing device of the recipient upon authentication of the death of the user. Additionally or alternatively, the third alternative method may include in response to receiving the unique, recipient-specific encryption key, generating and transmitting to the computing device, at one or more user-specified or algorithmically determined times, age progressed images of the user aged up to an age the user would have been at the one or more user-specified or algorithmically determined times.

Note that any of the methods described herein can be combined with each other and/or performed in tandem, cooperatively with each other. Furthermore, any of the functionalities described herein may be added to the various methods described above without departing from the scope of the technology herein.

In summary, this posthumous memory-sharing system combines automated content organization, adaptive release timing, personalized delivery, and strong data security to provide a uniquely meaningful remembrance experience. By integrating real-time sentiment feedback, AI-driven content prioritization, and multi-layer verification, the system offers a secure and highly personalized approach that honors the user's legacy and enhances the emotional connection between the deceased and their loved ones. The thoughtful blend of digital and physical memory-sharing elements creates an enduring and compassionate posthumous communication experience.

Furthermore, the disclosed posthumous memory-sharing system represents a practical application that significantly improves technology in the field of posthumous communication. Unlike traditional methods of delivering posthumous messages or memory sharing, this system combines advanced digital and physical memory-sharing features to offer a unique and emotionally resonant remembrance experience. By integrating automated content storage, adaptive scheduling, and personalized delivery mechanisms, the invention provides an innovative and technologically enhanced way of honoring a user's legacy, far surpassing static, conventional approaches. For example, the system's scheduling module enables memories to be released on meaningful dates, such as anniversaries or birthdays, ensuring that each message resonates deeply with recipients. This is achieved through the system's highly customizable scheduling options, making the invention a practical solution that addresses the specific challenges of personalized posthumous memory sharing.

The system further avoids the limitations of mental processes by implementing complex computational steps that cannot be performed by human thought alone. Critical functions within the system, such as verifying the user's death through multi-layered sources, encrypting each memory with unique, recipient-specific keys, and analyzing real-time feedback, necessitate sophisticated machine processing. For instance, the verification module integrates biometric data, third-party validations, and cross-referencing with external sources, ensuring the secure and accurate confirmation of the user's passing. These verification steps cannot be managed mentally and require computational algorithms to handle the breadth and complexity of data. Similarly, the sentiment analysis module that tracks recipients'interactions with delivered memories—adjusting future deliveries based on engagement metrics—demands real-time data processing capabilities that exceed human capacity. Additionally, the AI-driven media enhancement tool and machine learning algorithms used to prioritize memories based on emotional significance are technologically intensive and cannot be performed in the mind.

This system also introduces several non-conventional, non-routine, and inventive elements that distinguish it from traditional approaches. The memory storage array, for example, is designed to prioritize content using metadata that assigns emotional significance ratings, creating a hierarchy that ensures the most impactful memories are shared first. This hierarchical data structure, augmented by machine learning, allows the system to customize memory selection based on each recipient's relationship with the user, a feature that is neither routine nor well-known in memory-sharing applications. The encryption protocol is similarly inventive, with recipient-specific keys generated for each release, paired with a self-destruct function that protects against unauthorized access. This unique encryption approach provides a layer of security tailored specifically to posthumous communication, ensuring that memories are accessible only to the intended recipients. Moreover, the system's adaptive scheduling, enhanced by predictive models, leverages an atomic clock to deliver content with long-term precision, enabling the release of memories across years with accuracy—a feature uncommon in standard data scheduling systems.

In addition, the system's automated dispatch controller connects with third-party vendors to handle the delivery of physical items, such as flowers and personalized gifts, creating a hybrid memory-sharing experience that combines digital and tangible elements. By accessing real-time inventory data from vendors, the system can adjust dispatch schedules or substitute items based on availability, demonstrating a responsive, inventive solution to potential logistical challenges. This flexibility in physical item dispatch, along with adaptive content selection and scheduling, showcases how the invention provides a practical solution that goes beyond typical memory-sharing technology by improving both the reliability and emotional impact of posthumous communication.

Furthermore, the system's adaptive, emotionally-responsive scheduling also exemplifies an inventive step by allowing memory releases to be dynamically adjusted based on significant events, recipient availability, and even location-based triggers. For example, the location-aware scheduling feature can delay memory release if a recipient is at a sensitive location, such as a family gathering, ensuring that the timing of memory delivery is both appropriate and meaningful. This level of nuanced scheduling, combined with predictive algorithms that suggest optimal delivery dates based on user history, reflects an innovative approach to content release that is deeply personalized and responsive to recipient needs.

In sum, this disclosure delivers a practical, non-mental solution with inventive elements that enhance posthumous memory-sharing technology. By integrating advanced computing techniques—such as machine learning, sentiment analysis, and personalized encryption—the system offers a uniquely secure and emotionally resonant approach that aligns with modern standards for patent eligibility. This comprehensive blend of digital and physical memory-sharing capabilities, adaptive scheduling, and multi-layered security measures demonstrates a significant advancement in the technological field of posthumous communication, providing practical application and inventive steps.

In some embodiments the methods, tasks, processes, and/or operations described herein may be automatically effected, executed, actualized, and/or carried out by a computing system including a tangible computer-readable storage medium, also described herein as a storage machine, that holds machine-readable instructions executable by a logic machine (i.e. a processor or programmable control device) to effect, execute, actualize, carry out, provide, implement, perform, and/or enact the above described methods, processes, operations, and/or tasks. When such methods, operations, and/or processes are implemented, the state of the storage machine may be changed to hold different data. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that a certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

The disclosure includes the practical application of a processor (logic machine), and this practical application may include the receiving of an input through a graphical user interface (GUI) such as a user selection to execute one or more tasks or operations. Such a practical application may include the automatic operation of one or more data-or state-determining tasks in response to such a user selection or user input. The practical application as such may automatically execute any of the herein operations based on automatically determining any of the disclosed values, data, informatics, or states.

As a non-limiting example of such a practical application, embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, source or object code, or the like written in any combination of one or more programming languages, including an object oriented programming language such as Java, Smalltalk, C++ or the like, and conventional procedural programming languages, such as the “C” programming language or similar programming languages. The computer readable program instructions may execute entirely on one or more standalone computers, partly on one or more standalone computers, as a stand-alone software package, partly on one or more standalone computers and partly on one or more remote computers, partly on one or more standalone computers and partly on one or more distributed computing environments (such as a cloud environment), partly on one or more remote computers and partly on one or more distributed computing environments, entirely on one or more remote computers or servers, or entirely on one or more distributed computing environments. Standalone computers, remote computers, and distributed computing environments may be connected to each other through any type of network or combination of networks, including local area networks (LANs), wide area networks (WANs), through the Internet (for example using an Internet Service Provider), or the connection may be made to external computers. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the disclosed technology are described herein with reference to schematic flowchart illustrations and/or block diagrams of methods, apparatus (systems), functions, and computer program products according to embodiments of the invention. It will be understood that each block of the flowchart illustrations and/or block diagrams, and combinations of blocks in the flowchart illustrations and/or block diagrams or functions, can be implemented by computer readable program instructions. Functions, including policy functions, are groups of computer readable program instructions grouped together that can be invoked to complete one or more tasks.

These computer readable program instructions may be provided to one or more processors of one or more general purpose computers, special purpose computer, or other programmable data processing apparatus to produce a machine, such that the instructions, which execute via the processors of the one or more computers or other programmable data processing apparatus, create means for implementing the functions/acts specified in the flowchart and/or block diagram block or blocks. These computer readable program instructions may also be stored in one or more computer readable storage mediums that can direct one or more computers, programmable data processing apparatuses, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto one or more computers, one or more processing elements, other programmable data processing apparatus, or other devices to cause a series of operational steps to be performed on the one or more computers, other programmable apparatuses or other device to produce a computer implemented process, such that the instructions which execute on the computers, other programmable apparatus, or other devices implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the present computing system, the operations are carried out by one or more processors executing computer-readable instructions stored in memory. The processes performed by the computing system are not able to be effectively carried out in the human mind due to the complexity, volume, and speed required to achieve the system's functionality. The computing system is configured to handle operations that require processing large datasets, real-time data analysis, and automatic decision-making at a speed and accuracy level beyond human capability. Consequently, this system performs tasks that cannot practically be completed mentally, meeting the need for a computational infrastructure to execute these high-volume and high-speed operations.

The computing system disclosed here constitutes a practical application and an improvement to technology in the field of the invention. Through its ability to store, process, and analyze data with a precision and consistency unattainable through conventional methods, the system achieves greater efficiency and reliability. This improvement to technology addresses specific challenges in the relevant field by offering a solution that enhances operational performance, accuracy, and scalability, contributing to advancements in automated data handling, processing, and output generation.

Furthermore, the computing system employs non-conventional, non-routine, and non-well-known techniques and components. Rather than relying solely on standard hardware and generic software instructions, the system uses inventive concepts that integrate specialized algorithms, customized data processing methods, and unique communication protocols. These inventive aspects allow the system to deliver a level of functionality and adaptability that is distinct from conventional computing solutions, addressing unique needs in a way that is novel and inventive within the field.

The system architecture is configured to incorporate several non-standard components that work in conjunction to achieve an optimal solution to the technical challenges presented. This includes, but is not limited to, the use of custom-configured processing units, specialized memory structures, and network interfaces that facilitate high-speed and secure data exchange. The combined effect of these inventive components provides enhanced reliability, speed, and processing power, allowing the system to function as a highly efficient solution to the problem at hand of safely, reliably, and efficiently providing digital content and physical gifts or items to one or more recipients from a user posthumously.

In summary, the disclosed computing system goes beyond conventional methods and systems by leveraging non-routine concepts in data processing and computing infrastructure. The result is a practical application that enhances technology in the relevant field, operating at a level of complexity and functionality that cannot be performed in the mind and that advances the state of the art through non-routine, non-conventional means.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, modules, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an app, an application, or an application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element”, “processor”, “computing device”, or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. The terms “may” or “can be” as used herein denote that the features, method steps, or functionality that follow those terms are to be considered included in one or more embodiments of the invention but can also be omitted from one or more embodiments without departing from the scope of the invention.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A posthumous memory-sharing system comprising:
a computing device of a recipient having at least one processor and at least one memory device, wherein the computing device is communicably coupled with a memory storage system associated with a user and storing user-selected digital content, the computing device configured to:
receive verification from the memory storage system authenticating death of the user, wherein the authenticating of the user's death requires at least one of biometric data and third-party data validation;
in response to receiving the verification of the death of the user, transmit a unique, recipient-specific encryption key indicating that the recipient wishes to receive any of the user-selected digital content or at least one physical item associated in the memory storage system with the recipient;
receive from the memory storage system, in response to the transmission of the unique, recipient-specific encryption key:
one or more of the user-selected digital content at user-specified or algorithmically determined times, or
an alert regarding upcoming delivery of the at least one physical item at the user-specified or algorithmically determined times; and
dynamically adjust delivery schedules of the one or more of the user-selected digital content or the at least one physical item based on at least one of recipient availability and real-time interaction feedback received by the computing device to enhance the personalization and emotional impact of the shared content.

2. The posthumous memory-sharing system of claim 1, wherein the user-selected digital content, includes one or more of audio, video, images, GIFs, and text files, wherein the content is organized and prioritized based on at least one of user-defined metadata and user-defined recipient relationship.

3. The posthumous memory-sharing system of claim 1, wherein the user-specified or algorithmically determined times include at least one of significant dates and recurring events.

4. The posthumous memory-sharing system of claim 1, further comprising the memory storage system, wherein the memory storage system is configured to coordinate with third-party providers to purchase and send physical items based on user selections prior to the death of the user.

5. The posthumous memory-sharing system of claim 1, wherein the computing device is configured to, in response to the transmission of the unique, recipient-specific encryption key, receive from the memory storage system data regarding the user's will, trust, funeral instructions, and data regarding prepaid burial arrangements.

6. The posthumous memory-sharing system of claim 1, wherein the computing device is configured to, in response to the transmission of the unique, recipient-specific encryption key, receive age progressed images of the user for a given date based on a date associated with an image of the user retrieved from the memory storage system.

7. The posthumous memory-sharing system of claim 1, wherein the computing device is configured to, in response to the transmission of the unique, recipient-specific encryption key, receive and display at least one of memory books and health books providing health and medical records related to the user.

8. Non-transitory computer-readable storage media having computer-executable instructions for posthumous gifting, wherein when executed by at least one processor, the computer-executable instructions cause the at least one processor to:
verify a user's death upon receipt of third-party data validation;
at user-specified or algorithmically determined dates or times following verification of the user's death, instruct the at least one processor to at least one of:
release or send stored digital content to one or more designated recipients, and
initiate dispatch of one or more physical items to the one or more designated recipients for delivery at the user-specified or algorithmically determined dates or times;
receive from at least one of the one or more designated recipients availability information or sentiment feedback; and
automatically adjust schedules for the releasing, the sending, or the delivery of at least one of the stored digital content and the one or more physical items based on the availability information or the sentiment feedback to enhance personalization and emotional impact of the digital content or the one or more physical items.

9. The non-transitory computer-readable storage media of claim 9, wherein the user-specified or algorithmically determined dates or times include at least one of significant dates and recurring events.

10. The non-transitory computer-readable storage media of claim 9, wherein the digital content comprises at least one of user-selected audio, video, images, GIFs, and text files.

11. The non-transitory computer-readable storage media of claim 4, wherein the digital content is organized and prioritized based on user-defined metadata and recipient relationship data.

12. The non-transitory computer-readable storage media of claim 9, wherein the computer-executable instructions further cause the at least one processor to generate unique, recipient-specific encryption keys for each scheduled release, ensuring secure access to the digital content.

13. The non-transitory computer-readable storage media of claim 9, wherein the computer-executable instructions further cause the at least one processor to transmit the digital content over secure, multi-channel networks, including cellular and satellite connections, to reach recipients regardless of location.

14. The non-transitory computer-readable storage media of claim 9, wherein the computer-executable instructions further cause the at least one processor to coordinate with third-party providers to purchase and send physical items based on user selections prior to the user's death, wherein the physical items include at least one of flowers, cards, keepsakes, jewelry, toys, clothes, a hologram box, a 3D-printed image, and a food item.

15. A posthumous memory-sharing system comprising:
a memory storage system having at least one processor and at least one memory device and storing user-selected digital content and instructions for communicating with a computing device of a recipient, wherein the memory storage system is communicably coupled with the computing device, the memory storage system configured to:
authenticate death of the user based on receiving at least one of biometric data and third-party data validation;
transmit verification to the computing device that the death of the user has been authenticated;
receive a unique, recipient-specific encryption key indicating that the recipient wishes to receive at least some of the user-selected digital content or at least one physical item associated in the memory storage system with the recipient;
in response to the transmission of the unique, recipient-specific encryption key:
send one or more of the user-selected digital content at user-specified or algorithmically determined times, or
initiate delivery of the at least one physical item at the user-specified or algorithmically determined times; and
dynamically adjust delivery schedules of the one or more of the user-selected digital content or the at least one physical item based on at least one of recipient availability and real-time interaction feedback received by the computing device to enhance the personalization and emotional impact of the shared content.

16. The posthumous memory-sharing system of claim 15, wherein the memory storage system is further configured to receive the user-selected digital content from the user prior to the death of the user, and wherein the user-selected digital content includes one or more of audio, video, images, GIFs, text files, memory books, and health books providing health and medical records related to the user.

17. The posthumous memory-sharing system of claim 15, wherein the user-specified or algorithmically determined times include recurring events.

18. The posthumous memory-sharing system of claim 15, wherein the memory storage system is further configured to coordinate with third-party providers to purchase and send the at least one physical item based on user selections prior to the death of the user.

19. The posthumous memory-sharing system of claim 15, wherein the memory storage system is further configured to transmit data regarding the user's will, trust, funeral instructions, and data regarding prepaid burial arrangements to the computing device upon authentication of the death of the user.

20. The posthumous memory-sharing system of claim 15, wherein the memory storage system is configured to, in response to receiving the unique, recipient-specific encryption key, generate and transmit to the computing device, at one or more user-specified or algorithmically determined times, age progressed images of the user aged up to an age the user would have been at the one or more user-specified or algorithmically determined times.
